(19) United States
(12) Patent Application Publication
(10) Pub. No.: US 2026/0344636 A1
(43) Pub. Date: Nov. 5, 2026

(54) Fishing Line Attachment Device and Method of Use

(71) Applicants: Yevhen Voitiuk, Agoura Hills, CA (US); Kostiantyn Voitiuk, Agoura Hills, CA (US)

(72) Inventors: Yevhen Voitiuk, Agoura Hills, CA (US); Kostiantyn Voitiuk, Agoura Hills, CA (US)

(21) Appl. No.: 19/194,197

(22) Filed: Apr. 30, 2025

(51) Int. Cl. A01K 91/06; A01K 97/24

(52) U.S. Cl. CPC A01K 91/065; A01K 97/24

(57) ABSTRACT

A fishing line attachment device may comprise a body having a bent oval shape and formed from a transparent, rigid plastic material. The body may define a plurality of holes in a central region for attaching the device to a fishing line. The body may have a width-to-length ratio of approximately 1:3. The body may include a sunken middle portion with curved sides. The plurality of holes may comprise between 3 and 5 holes. The device may further comprise at least one of fixations or rings for securing the device in a desired position on the fishing line. The rigid plastic material may enable the body to flex and snap back upon release of force. The body may be configured to generate a lifting force when pulled through water. The body may be configured to create a jolting motion when quickly released and pulled.

### FIELD

The present disclosure relates generally to fishing equipment, and more particularly to devices attachable to fishing lines.

### BACKGROUND

Fishing is a popular recreational activity enjoyed by many people around the world. However, fishers often encounter challenges when their fishing lines become entangled or snagged on underwater obstacles such as vegetation, rocks, or debris. These entanglements can lead to line breakage, resulting in the loss of fishing equipment and potential environmental pollution from discarded gear.

Traditional fishing practices often result in significant environmental and economic challenges. The loss of fishing equipment, particularly lead weights, in bodies of water may contribute to pollution and habitat degradation. Research has indicated that approximately 2,000 to 6,000 tons of lead may be lost in bodies of water across the United States due to fishing activities. This loss of equipment not only impacts the environment but also represents a financial burden for fishers who must frequently replace lost gear.

Line breaks and equipment loss may occur when fishing lines become entangled or snagged on underwater obstacles. These obstacles may include submerged vegetation, rocks, or other debris commonly found in aquatic environments. When a line becomes snagged, attempts to free it may result in breakage, leading to the loss of attached equipment such as hooks, lures, and weights.

The loss of fishing gear may have far-reaching consequences beyond the immediate economic impact on individual fishers. Discarded or lost fishing equipment may persist in aquatic environments for extended periods, potentially harming wildlife through entanglement or ingestion. Additionally, the accumulation of lead weights in water bodies may pose risks to aquatic ecosystems and potentially impact water quality.

Efforts to address these challenges may focus on developing methods or devices to reduce the likelihood of line breaks and equipment loss. Such solutions may aim to assist in lifting fishing lines and attached elements out of potential snag situations, thereby preserving fishing equipment and reducing environmental pollution. Improvements in this area may have the potential to benefit both recreational and commercial fishing practices, as well as contribute to the conservation of aquatic ecosystems.

Various devices and methods have been developed to address the issue of line entanglement and breakage. However, there remains a need for improved solutions that can effectively assist in lifting fishing lines and attached elements out of underwater obstructions while being easy to use and environmentally friendly.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The present disclosure provides a fishing line attachment device and methods for its use. In various embodiments, the device may assist in lifting a fishing line and its attached elements out of underwater obstructions, potentially reducing line breakage and equipment loss.

In one aspect, a fishing line attachment device is provided. The device may include a body having a bent oval shape and formed from a transparent, rigid plastic material. The body may define a plurality of holes in a central region for attaching the device to a fishing line. The body may have a width-to-length ratio of approximately 1:3 and may include a sunken middle portion with curved sides.

In another aspect, a method of using a fishing line attachment device is provided. The method may include threading a fishing line through holes in a central region of the device, positioning the device on the line near weight sinkers, casting the line into water, and applying an upward force to the line when retrieving or sensing entanglement. The device may generate a lifting force and potential jolting motion to assist in dislodging the line and attachments from underwater obstructions.

In yet another aspect, a fishing system is provided. The system may include a fishing rod, a fishing line, and a fishing line attachment device. The device may include a body having a bent oval shape and formed from a transparent, rigid plastic material. The body may define a plurality of holes in a central region for attaching the device to the fishing line. The device may be positioned on the line near weight sinkers to assist in lifting the line and attached elements out of underwater obstructions.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram illustrating various embodiments of a fishing line attachment device according to the present disclosure, including different shapes and configurations for attaching the device to a fishing line;

FIG. 2 is a diagram illustrating the operation of a fishing line attachment device according to the present disclosure, showing the device's behavior when discarded and its movement on a slope;

FIG. 3 is a diagram showing a top view of a fishing line attachment device according to the present disclosure, illustrating the transparent and flexible nature of the device;

FIG. 4 is a diagram depicting a side view of a fishing line attachment device according to the present disclosure, highlighting the central raised portion;

FIG. 5 is a diagram illustrating an alternative embodiment of a fishing line attachment device according to the present disclosure, showing a circular shape with a central raised point;

FIG. 6 is a diagram showing a perspective view of a fishing line attachment device according to the present disclosure, emphasizing the transparent material and slightly raised edge;

FIG. 7 is a diagram depicting another embodiment of a fishing line attachment device according to the present disclosure, illustrating a circular shape with an irregular edge and central elevated point;

FIG. 8 is a diagram showing a top view of yet another embodiment of a fishing line attachment device according to the present disclosure, highlighting a ridged surface with a central darker spot;

FIG. 9 is a diagram illustrating a fishing hook with an attached circular weight, demonstrating a potential configuration for use with the fishing line attachment device according to the present disclosure;

FIG. 10 is a diagram depicting a fishing hook attached to a round, flat, metallic object, showing another potential configuration for use with the fishing line attachment device according to the present disclosure; and

FIG. 11 is a diagram illustrating a fishing hook attached to a round, flat sinker, demonstrating an additional configuration for use with the fishing line attachment device according to the present disclosure.

The drawings described herein are for illustration purposes only and are not intended to limit the scope of the present disclosure in any way.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase “at least one of” A, B, and C should be construed to mean a logical (A or B or C), using a non-exclusive logical OR. It should be understood that steps within a method may be executed in different order without altering the principles of the present disclosure.

The present disclosure provides a fishing line attachment device, also referred to as a “Parachute,” and methods for its use. The device is designed to assist in lifting a fishing line and its attached elements out of underwater obstructions, potentially reducing line breakage and equipment loss.

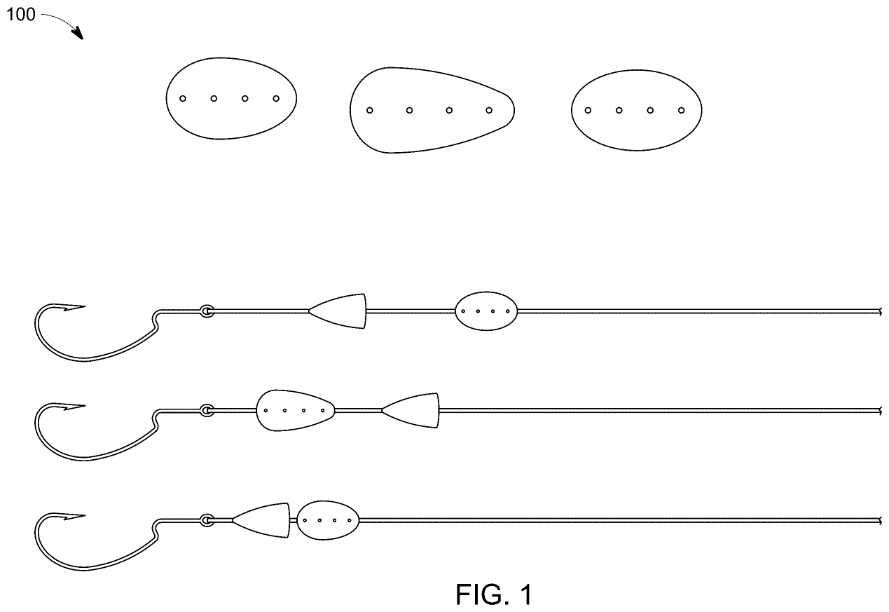

Referring now to FIG. 1, an embodiment of the fishing line attachment device 100 of the present invention is illustrated. The device 100 comprises a body 102 having a bent oval shape and formed from a transparent, rigid plastic material. The body 102 defines a plurality of holes 104 in a central region for attaching the device to a fishing line. In this embodiment, the number of holes 104 is three, but other numbers of holes are contemplated within the scope of the invention.

The body 102 has a width-to-length ratio of approximately 1:3, providing an elongated shape that contributes to its hydrodynamic properties. The body 102 includes a sunken middle portion 106 with curved sides 108, resembling the shape of a paraglider parachute. This unique shape is designed to generate lift when pulled through water, assisting in raising the fishing line and attached elements. The transparent, rigid plastic material of the body 102 serves multiple purposes. The transparency helps to minimize visibility in clear water conditions, reducing the likelihood of spooking fish. The rigidity of the material allows the body 102 to flex and snap back upon release of force, creating a jolting motion that can assist in dislodging snagged lines.

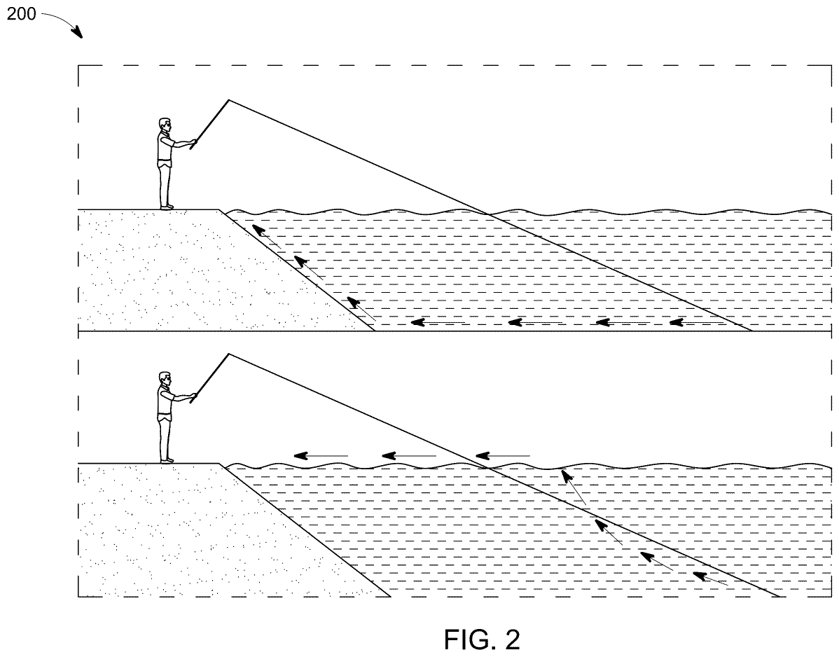

FIG. 2 illustrates the fishing line attachment device 100 in use. When the fishing line is cast, as shown in the upper portion of FIG. 2, the device 100 remains in a neutral position, allowing for normal casting dynamics. The arrows indicate the various forces acting on the device during casting. The lower portion of FIG. 2 demonstrates the behavior of the device 100 when tension is applied to the fishing line, such as during retrieval or when attempting to free a snagged line. As indicated by the arrows, the device 100 generates an upward force, assisting in lifting the line and attached elements. This lifting action can help to dislodge hooks or weights that may have become caught on underwater obstacles.

The bent oval shape and sunken middle portion of the device 100 contribute to its ability to create this lifting force. As water flows over the curved surfaces of the body 102, it creates areas of low pressure above the device, similar to the principle that allows airplane wings to generate lift. This hydrodynamic effect helps to counteract the downward force of attached weights and aids in raising the line. The flexibility of the body 102 allows it to bend under tension and then quickly return to its original shape when tension is released. This spring-like action can create a jolting motion in the water, which can be particularly effective in freeing snagged lines or lures. The fisherman can take advantage of this property by quickly releasing and pulling the fishing rod, as described in the method claims.

It should be noted that while the device 100 is shown here with three holes 104, other configurations are possible. For example, the device may have between three and five holes, allowing for different attachment methods or positions on the fishing line. Additionally, the device 100 may include fixations or rings (not shown) for securing it in a desired position on the line.

The Parachute may also serve an additional function in potentially attracting fish towards the hook. As the device moves through the water, it may create disturbances or vibrations that could draw the attention of nearby fish. The transparent material of the body 102 may allow light to pass through and create reflections or refractions in the water, which may mimic the appearance of small prey or baitfish.

The movement of the Parachute through the water as the line is retrieved or manipulated may resemble the motion of swimming baitfish. This lifelike action could potentially entice predatory fish to investigate and strike at the nearby hook. The curved sides 108 and sunken middle portion 106 of the body 102 may cause the device to wobble or oscillate slightly as it moves, further enhancing its fish-attracting properties.

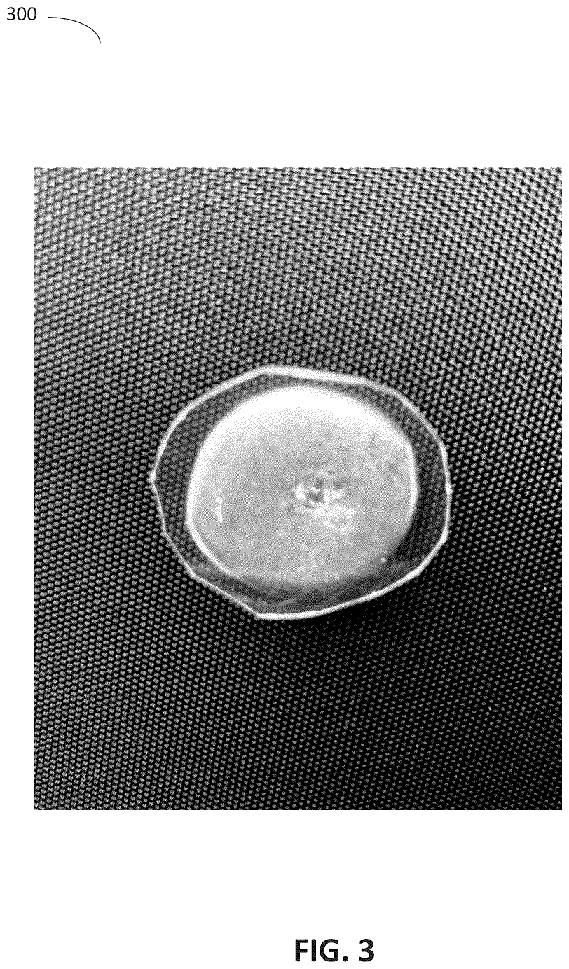

The fishing line attachment device 100 may be manufactured in various sizes to accommodate different weight sinkers and fishing conditions. FIG. 3 illustrates a smaller version of the device 500, which may be suitable for use with lighter weight sinkers or in situations where a more subtle presence in the water is desired. The device 500 maintains the characteristic bent oval shape and transparent material of the larger version, but with reduced overall dimensions.

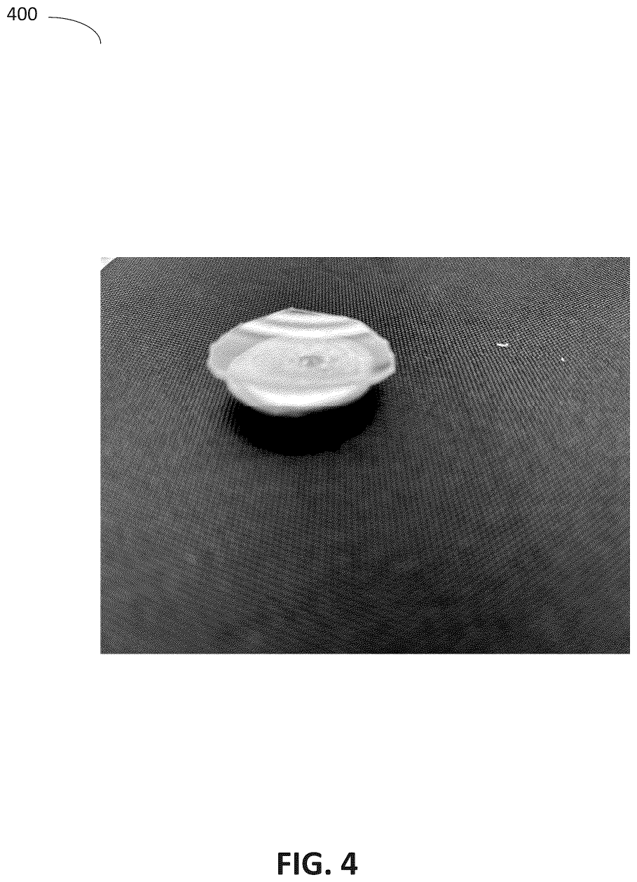

FIG. 4 shows another variation of the device 600, which may feature a more circular profile while still incorporating the sunken middle portion and curved sides. This circular variant may provide different hydrodynamic properties compared to the oval shape, potentially offering advantages in certain fishing scenarios.

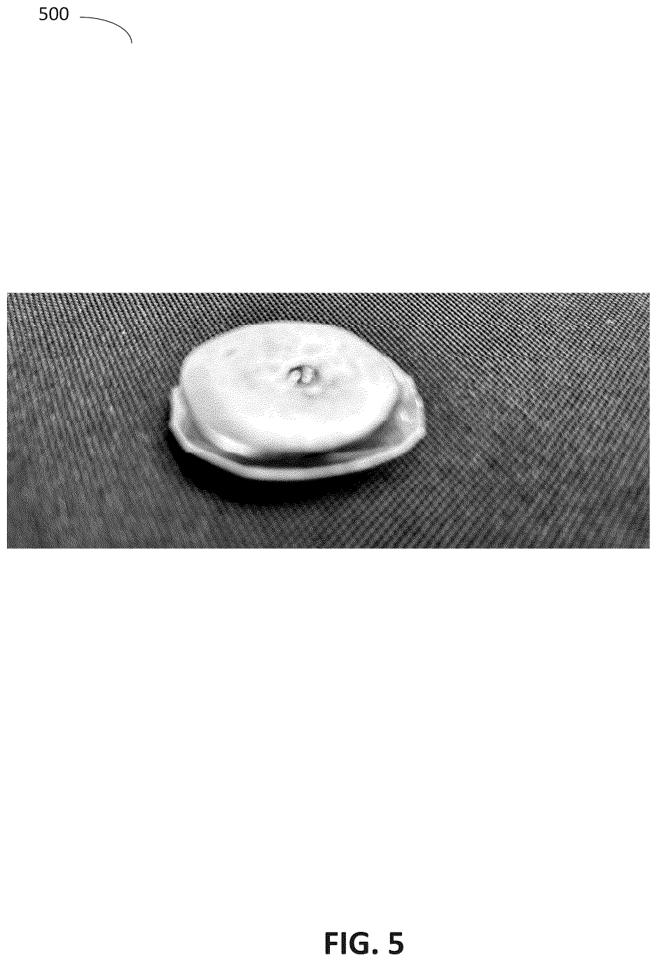

In FIG. 5, a device 700 with a more pronounced central raised point is depicted. This design may enhance the device's ability to create water disturbances, potentially increasing its fish-attracting properties. The raised central point may also serve to further concentrate the lifting force generated by the device.

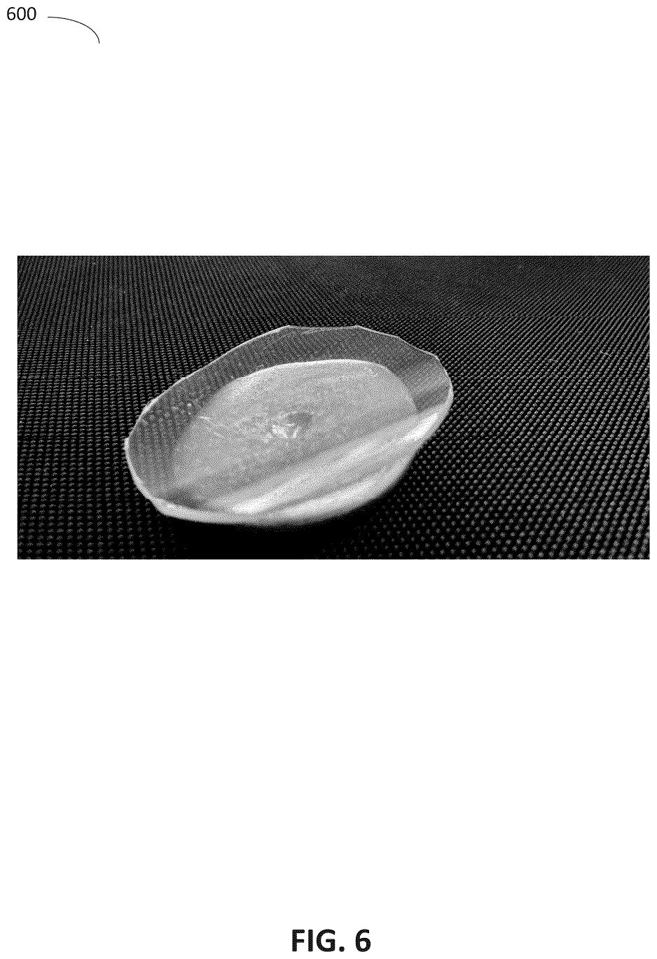

FIG. 6 illustrates a device 800 with a smoother, more lens-like profile. This streamlined design may offer reduced water resistance during casting while still maintaining the lifting capabilities when tension is applied to the line. The smooth surface may also be less likely to catch on underwater vegetation.

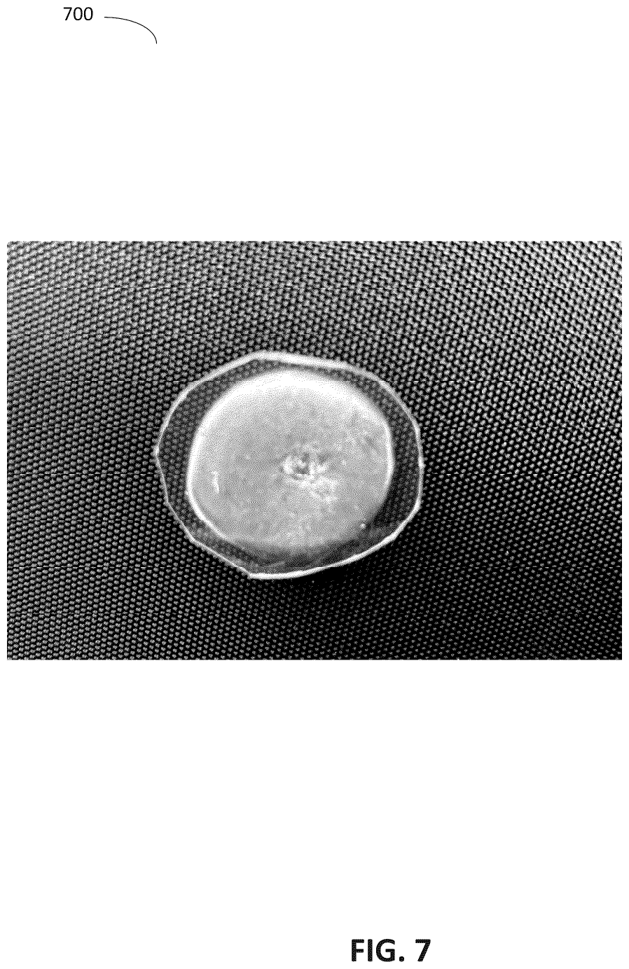

A variation with multiple raised points is shown in FIG. 7. This device 900 may create more complex water disturbances and vibrations as it moves through the water, potentially enhancing its fish-attracting capabilities. The multiple raised points may also provide additional structural integrity to the device.

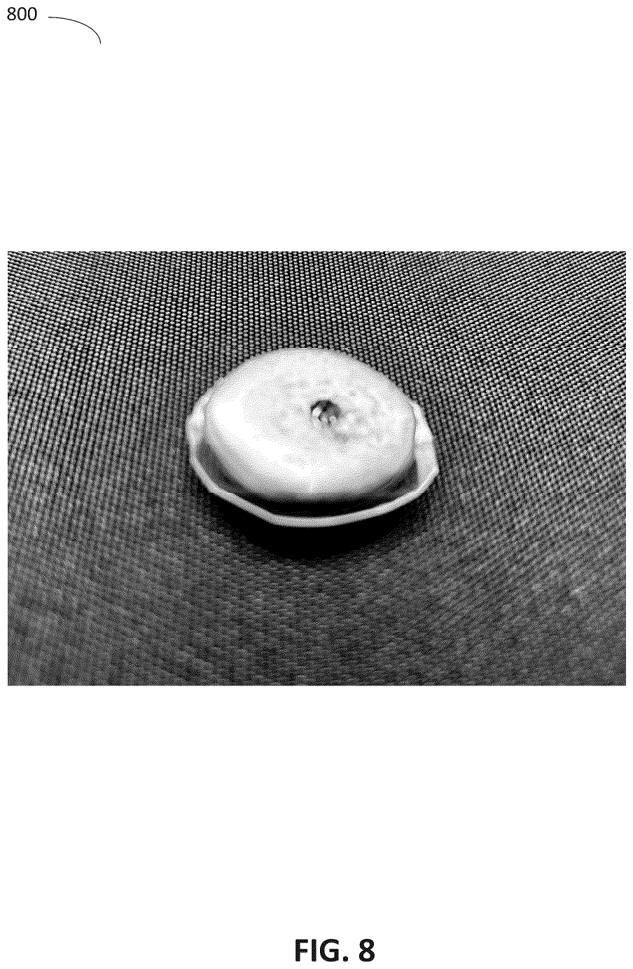

FIG. 8 depicts a device 1000 with a ridged surface. These ridges may serve to create additional turbulence in the water as the device moves, potentially increasing its lifting force and fish-attracting properties. The ridges may also provide additional grip for secure attachment to the fishing line.

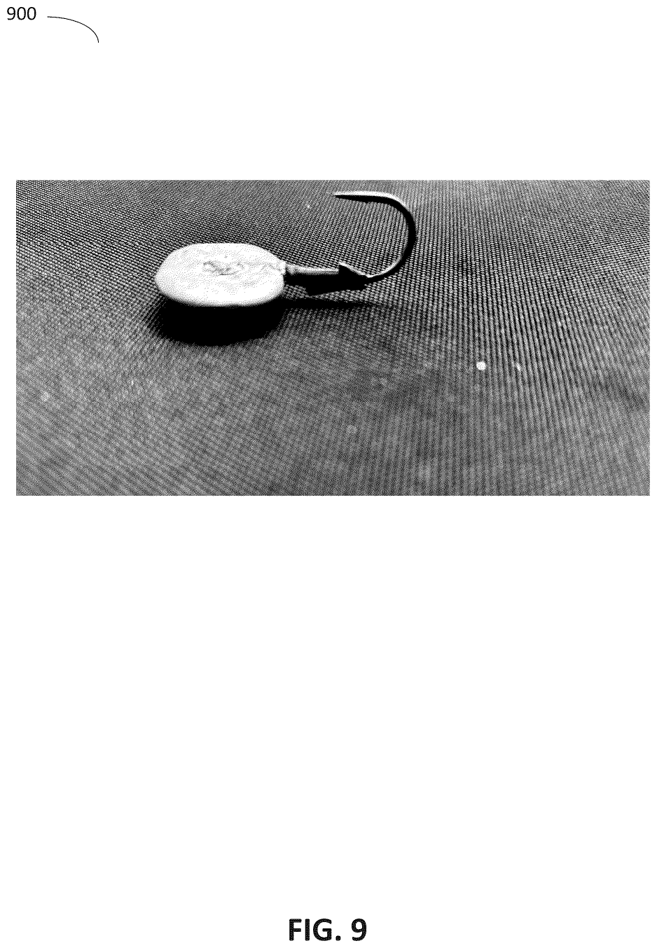

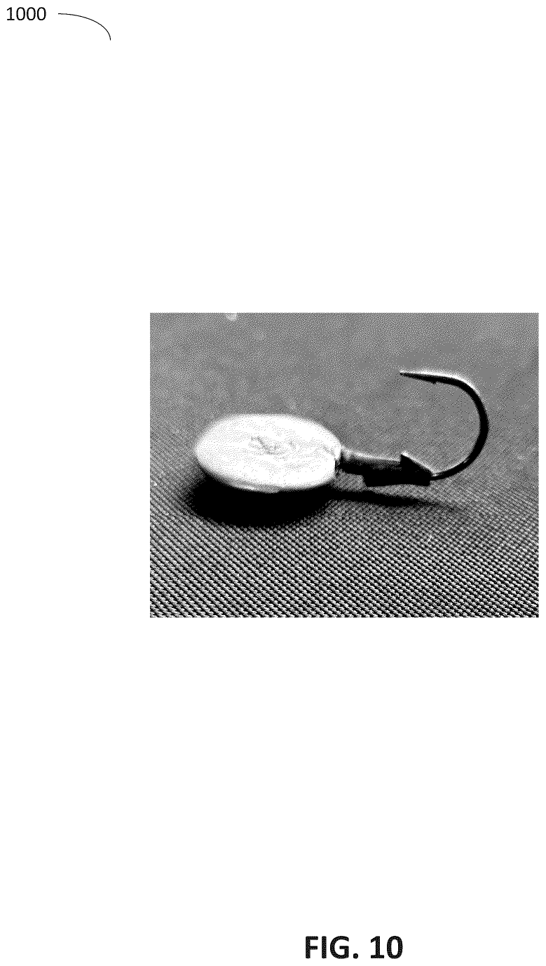

FIGS. 9 and 10 illustrate how the fishing line attachment device may be used in conjunction with traditional fishing equipment. In FIG. 9, a device 1100 is shown attached near a conventional fishing hook and weight. This configuration may allow the device to assist in lifting both the hook and weight out of underwater obstructions.

FIG. 10 shows a similar configuration, but with the device 1200 positioned slightly differently on the line. This illustrates the flexibility in positioning that the device may offer, allowing anglers to adjust its placement for optimal performance in various fishing conditions.

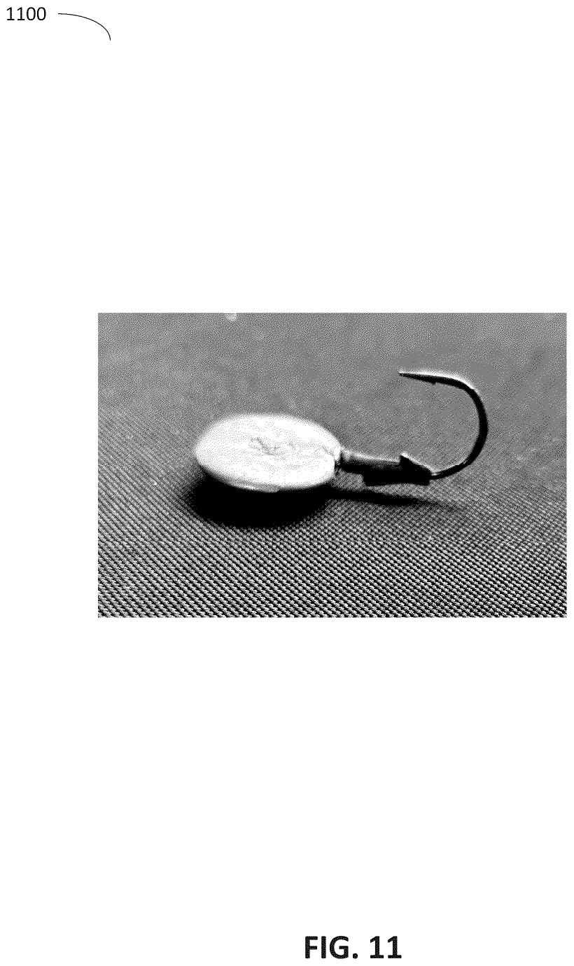

FIG. 11 provides another view of how the device 1300 may be integrated into a typical fishing rig. This configuration may demonstrate how the device can be used alongside standard fishing equipment without requiring significant changes to an angler's usual setup.

These various embodiments and configurations of the fishing line attachment device may provide anglers with a range of options to suit different fishing styles, target species, and water conditions. The flexibility in design and positioning may allow for customization and optimization of the device's performance in a wide variety of fishing scenarios.

When the fisherman applies tension to the line, causing the Parachute to rise in the water column, this upward motion may trigger a predatory response in fish, simulating the behavior of prey attempting to escape. The subsequent release of tension, allowing the device to sink back down, may mimic injured or disoriented prey, which could be particularly attractive to opportunistic predators.

The jolting motion created by the flexing and snapping back of the body 102 may produce sudden changes in direction or speed that could catch the attention of nearby fish. This erratic movement may be especially effective in triggering strikes from predatory species that are attracted to wounded or distressed prey.

The positioning of the Parachute near the weight sinkers may also place it in proximity to the hook and any attached bait or lure. This arrangement could potentially create a larger overall target for fish to strike at, increasing the chances of a successful catch. The combination of the Parachute's movement and any additional bait or lure may present a more convincing and enticing presentation to fish in the area.

The fishing line attachment device of the present disclosure may provide several technical advantages over conventional fishing equipment. The device may assist in lifting the fishing line and attached elements out of underwater obstructions, potentially reducing line breakage and equipment loss. This lifting action may be particularly beneficial in areas with dense vegetation or debris on the water bed.

The transparent nature of the device may help minimize visibility in clear water conditions. This reduced visibility may decrease the likelihood of spooking fish, potentially improving catch rates. The rigid plastic material used in the construction of the device may allow for a spring-like action, enabling the device to flex and snap back upon release of force. This flexing action may create a jolting motion in the water, which may be effective in freeing snagged lines or lures.

The device may be versatile in its application. It may be used with various types of fishing setups, including but not limited to Carolina Rigs and Texas Rigs. The device may be positioned at different points along the fishing line, allowing for customization based on the specific fishing conditions and techniques being employed.

Alternative embodiments of the fishing line attachment device may include variations in shape, size, and attachment methods. For example, the device may be produced in leaf or circular shapes in addition to the oval shape described earlier. These alternative shapes may provide different hydrodynamic properties, potentially suited for various fishing conditions or target species.

The number of holes in the central region of the device may vary. While the described embodiment features three holes, alternative versions may include between three and five holes. This variation may allow for different attachment methods or positions on the fishing line, providing flexibility to anglers in how they incorporate the device into their setups.

In some embodiments, the device may include fixations or rings for securing it in a desired position on the line. These additional features may provide more precise control over the device's placement, potentially enhancing its effectiveness in certain fishing scenarios.

The size of the device may be varied to match different weight sinkers. This scalability may allow the device to be effective across a range of fishing applications, from light freshwater fishing to heavier saltwater applications.

Methods of using the fishing line attachment device may include several steps. An angler may first select an appropriately sized device based on the weight sinker being used. The fishing line may then be threaded through the device's center holes. The device may be positioned on the line near the weight sinkers.

When casting the line, the device may remain in a neutral position, allowing for normal casting dynamics. During retrieval, or when sensing entanglement, the angler may apply an upward force to the line. This action may cause the device to generate a lifting force, assisting in raising the line and attached elements.

If the line becomes snagged, the angler may create a jolting motion by quickly releasing and pulling the fishing rod. This action may take advantage of the device's spring-like properties, potentially helping to dislodge the line from underwater obstructions.

When tension is released on the line, the device may return to its neutral position. This ability to transition between active and neutral states may allow the device to function effectively during both casting and retrieval phases of fishing.

The methods described may potentially transform the process of fishing line retrieval. In an initial state, a fishing line may be potentially snagged in water bed debris. The transformation process may involve the device creating a lift force when the line is pulled, helping to raise the line and attached elements. The spring-like action of the device may create a jolting motion. In the final state, the fishing line and attached elements may be successfully lifted and retrieved from the water bed, potentially avoiding breakage and equipment loss.

These methods may not only assist anglers in preserving their catch and equipment but may also help reduce pollution in water bodies. By potentially reducing the frequency of line breaks, the device may help minimize the amount of lost fishing equipment, including lead weight sinkers, that might otherwise accumulate on water beds over time.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

What is claimed is:

1. A fishing line attachment device comprising:
a body having a bent oval shape and formed from a transparent, rigid plastic material;
wherein the body defines a plurality of holes in a central region for attaching the device to a fishing line;
wherein the body has a width-to-length ratio of approximately 1:3; and
wherein the body includes a sunken middle portion with curved sides.

2. The device of claim 1, wherein the plurality of holes comprises between 3 and 5 holes.

3. The device of claim 1, further comprising at least one of fixations or rings for securing the device in a desired position on the fishing line.

4. The device of claim 1, wherein the rigid plastic material enables the body to flex and snap back upon release of force.

5. The device of claim 1, wherein the body is configured to generate a lifting force when pulled through water.

6. The device of claim 1, wherein the body is configured to create a jolting motion when quickly released and pulled.

7. A method of using a fishing line attachment device, the method comprising:
threading a fishing line through holes in a central region of the device;
positioning the device on the line near weight sinkers;
casting the line into water;
applying an upward force to the line when retrieving or sensing entanglement; and
generating, by the device, a lifting force and potential jolting motion to assist in dislodging the line and attachments from underwater obstructions.

8. The method of claim 7, further comprising creating a jolting motion by quickly releasing and pulling a fishing rod.

9. The method of claim 7, wherein the device remains in a neutral position during casting and initial submersion.

10. The method of claim 7, wherein the device returns to a neutral position when tension is released.

11. The method of claim 7, wherein the device is formed from a transparent, rigid plastic material.

12. The method of claim 11, wherein the rigid plastic material enables the device to flex and snap back upon release of force.

13. A fishing system comprising:
a fishing rod;
a fishing line; and
a fishing line attachment device comprising:
a body having a bent oval shape and formed from a transparent, rigid plastic material;
wherein the body defines a plurality of holes in a central region for attaching the device to the fishing line;
wherein the body has a width-to-length ratio of approximately 1:3; and
wherein the body includes a sunken middle portion with curved sides.

14. The system of claim 13, wherein the fishing line attachment device is positioned on the line near weight sinkers.

15. The system of claim 13, wherein the body of the fishing line attachment device is configured to generate a lifting force when pulled through water.

16. The system of claim 13, wherein the body of the fishing line attachment device is configured to create a jolting motion when quickly released and pulled.

17. The system of claim 13, wherein the plurality of holes comprises between 3 and 5 holes.

18. The system of claim 13, wherein the fishing line attachment device further comprises at least one of fixations or rings for securing the device in a desired position on the fishing line.

19. The system of claim 13, wherein the rigid plastic material enables the body to flex and snap back upon release of force.

20. The system of claim 13, wherein the fishing line attachment device is configured to assist in lifting the line and attached elements out of underwater obstructions, and wherein movement of the device in water can potentially lure fish towards the fishing hook.
